(19) United States
(12) Patent Application Publication
(10) Pub. No.: US 2011/0187071 A1
(43) Pub. Date: Aug. 4, 2011

(54) Rolling Bearing for a Suspension Thrust Bearing Device

(75) Inventors: Richard Corbett, Fondettes (FR); Chrstophe Houdayer, Semblancay (FR); Désiré Vidot, Joue-Les-Tours (FR); Cédric Brulard, Charentilly (FR); Jacques Charpentier, Tours (FR)

(73) Assignee: AKTIEBOLAGET SKF, Goteborg (SE)

(21) Appl. No.: 13/020,128

(22) Filed: Feb. 3, 2011

(30) Foreign Application Priority Data
Feb. 3, 2010 (EP) 10 305 109.0

(51) Int. Cl. B60G 15/00; F16C 33/76

(52) U.S. Cl. 280/124.155; 384/607

(57) ABSTRACT

A rolling bearing includes a bottom ring, a top ring having a skirt with at least one radial protrusion, and a plurality of rolling elements disposed between the rings. A seal is radially disposed between the top and bottom rings and includes an annular radial rib, the rib being positioned axially above the radial protrusion of the top ring skirt so as to interfere diametrically with the radial protrusion and configured to frictionally contact the skirt to attach the seal to the top ring, and a retainer configured to axially retain the bottom ring relative to the top ring. A suspension thrust bearing device includes the rolling bearing and a support element for the rolling bearing forming bearing means for a spring, and a suspension strut for a motor vehicle includes the suspension thrust bearing device.

### CROSS-REFERENCE TO RELATED APPLICATIONS

This application claims priority to European patent application no. 10305109.0, filed on Feb. 3, 2010, which is incorporated fully herein by reference.

### BACKGROUND OF THE INVENTION

The present invention relates to the field of rolling bearing adapted to the suspension thrust bearing devices used in particular on motor vehicles in the suspension struts of the steered road wheels.

The invention relates more particularly to a rolling bearing comprising a top ring and a bottom ring between which are positioned a seal and rolling elements, for example balls or rollers. The top and bottom rings may be mounted in contact with bottom and top bearing or support pieces, such as covers or cups. The top and bottom cups form a housing for the rings of the rolling bearing and provide the interface between said rings and the neighboring elements.

A suspension thrust bearing device is positioned in the top part of the suspension strut between the bodywork of the vehicle and a suspension spring. The spring is fitted around a damping piston rod, the end of which is linked to the bodywork of the vehicle through an elastic block that filters the vibrations. The suspension spring axially bears, directly or indirectly, on the bottom cup. The top cup is fixed relative to the bodywork of the vehicle.

The rolling bearing makes it possible to transmit axial forces between the suspension spring and the bodywork of the vehicle, while allowing a rotation movement between the bottom cup and the filtering elastic block. This relative angular movement derives from a steer angle of the steered road wheels of the vehicle and/or the compression of the suspension spring.

For more detail, it is possible for example to refer to the French patent application FR-A1-2 688 836.

French patent application FR-A1-2 617 252 also discloses such a rolling bearing adapted to a suspension thrust bearing device. The disclosed rolling bearing comprises a bottom ring, a top ring and a seal disposed radially between said rings and adapted to axially retain the bottom ring relative to the top ring.

To fix the seal to the top ring, cut-out windows are formed on an external skirt of the top ring during stamping of said ring and external clipping sections are also foreseen on the seal to cooperate with said windows. This prevents the seal from moving both axially and radially between the rings.

To this end, French patent application FR-A1-2 816 550 discloses a top ring having an external skirt comprising bosses which are created by the displacement of metal material radially inwards. External sections of the seal may be clipped onto said bosses to block the seal between the two rings.

In both two latter prior art documents, during the rolling bearing assembly, the seal must be angularly oriented or indexed relative to the top ring before mounting. In fact, these designs of seals each use external clipping sections to mate with the associated cut-out windows or bosses of the top ring. This leads to an increase of the assembly time as well as the overall cost of the rolling bearing.

### SUMMARY OF THE INVENTION

One aim of the present invention is therefore to overcome the drawbacks of the prior as discussed above, particularly the necessity of orienting/indexing the seal relative to the top ring.

It is a particular object of the present invention to provide a rolling bearing, particularly adapted to a suspension thrust bearing device, which is simple to assembly and economic, while guaranteeing an efficient sealing to prevent the ingress of moisture, dust and other foreign matter into the bearing.

In one embodiment, the rolling bearing comprises a bottom ring, a top ring, at least one row of rolling elements mounted between the rings, and a seal radially disposed between said rings. The seal includes an annular radial rib, the rib being positioned above the radial protrusion of the top ring skirt so as to interfere diametrically with the radial protrusion and configured to frictionally contact the skirt to attach the seal to the top ring, and a retainer configured to axially retain the bottom ring relative to the top ring.

The seal has a relatively simple structure and can easily be mounted between the two rings of the rolling bearing because there is no need to angularly orient the seal relative to the top ring during the rolling bearing assembly due to the annular structure of the radial rib and to the frictional contact between said rib and the skirt, which prevents rotation of the seal after mounting.

Additionally, with such a circumferentially continuous rib extending radially, the seal has an improved static sealing with the top ring due to the external contact between said rib and the skirt of the top ring over 360°. “Static sealing” means the sealing made between two parts that do not move relative to one another.

In one embodiment, the skirt of the top ring extends axially.

Preferably, the external diameter of the annular radial rib of the seal in a free state is greater than the internal diameter of the skirt of the top ring so as to create an interference fit between said seal and said skirt.

In one embodiment, the seal includes an annular top radial surface in contact with a radial portion of the top ring to provide a further static sealing with said top ring. The contacting surfaces between the seal and the top ring are thus increased in order to have a better static sealing effect of the seal.

In a preferred embodiment, the seal comprises a chamfer in the form of a frustoconical surface disposed between the top radial surface and the annular radial rib.

In one embodiment, the skirt of the top ring comprises a plurality of radial protrusions spaced apart from one another in the circumferential direction. Alternatively, the skirt of the top ring comprises an annular radial protrusion. The radial protrusion(s) of the top ring may be obtained by deforming the skirt of the top ring axially.

The seal may also comprise an annular bottom radial surface radially offset outwards relative to the axially retaining means.

In one embodiment, the rolling bearing further comprises a cage configured to maintain a circumferential spacing between the rolling elements. The cage preferably has at least two extensions each frictionally contacting the bottom ring and the top ring. The cage is distinct from the seal disposed radially between the rings.

In one embodiment, the axially retainer includes an annular lip coming into friction contact with the bottom ring.

According to another aspect, it is proposed a suspension thrust bearing device comprising a rolling bearing as previously defined and a support element for the rolling bearing forming bearing means for a spring.

According to a further aspect, it is proposed a suspension strut for a motor vehicle comprising a suspension thrust bearing device as previously defined.

### BRIEF DESCRIPTION OF THE SEVERAL VIEWS OF THE DRAWINGS

The present invention and its advantages will be more readily understood by studying the detailed description of one specific embodiment, which constitutes a non-limiting example of the present invention, and illustrated by the appended drawings on which:

FIG. 1 is a view in axial section of a rolling bearing according to an example of the invention,

FIG. 2 is a part section on a larger scale of FIG. 1,

FIG. 3 is a part section of a top ring of the rolling bearing of FIG. 1,

FIG. 4 is an under view of the top ring of FIG. 3, and

FIG. 5 is an upper view of a seal of the rolling bearing of FIG. 1.

### DETAILED DESCRIPTION OF THE INVENTION

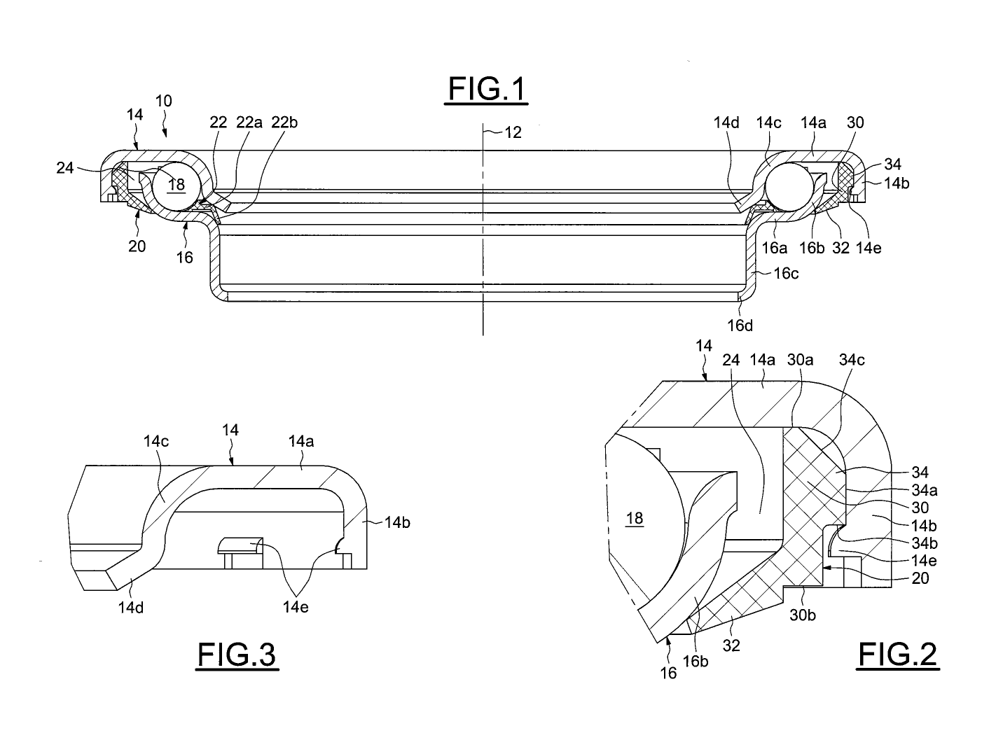

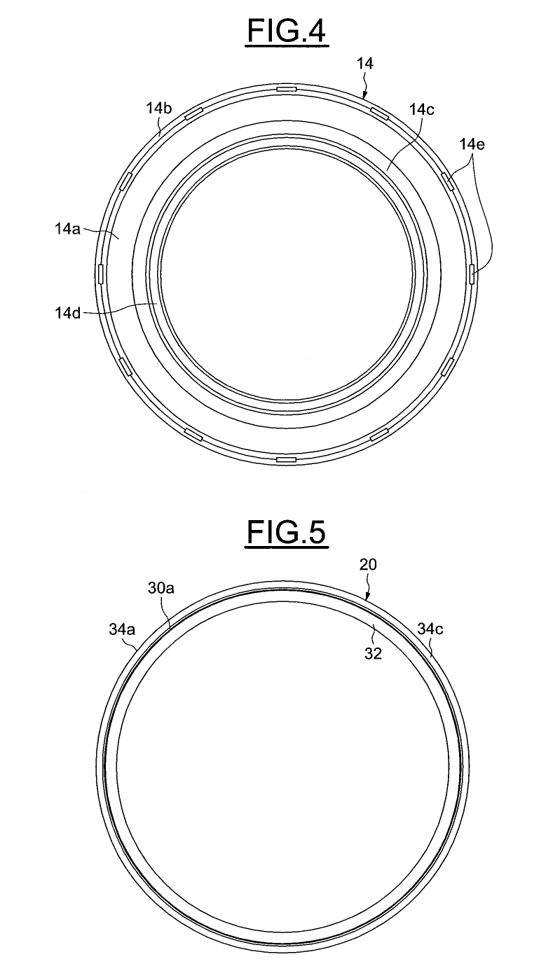

As illustrated on FIGS. 1 to 3, an example of rolling bearing 10, with an axis 12, comprises a top ring 14 and a bottom ring 16, between which is mounted a row of rolling elements 18, which in this case are balls. The rolling bearing 10 also comprises a seal 20 radially disposed between the rings 14, 16. A cage 22 is also provided between the rings so as to maintain an even circumferential spacing between the rolling elements 18.

The top ring 14 and the bottom ring 16 are made of a thin metal sheet, which has been stamped or rolled so as to define toroidal tracks or raceways for the rolling elements 18 between the two rings 14, 16.

The top ring 14 includes an annular radial portion 14a with an external annular axial skirt 14b of small thickness and of large diameter at this end, opposite to the rolling element 18, and extending axially downward. A small-diameter edge of the radial portion 14a is extended towards the inside and downward by a toroidal portion 14c. The concave external surface of the toroidal portion 14c forms the track or raceway for the rolling elements 18. The bottom end of the toroidal portion 14c is extended radially inwards and axially downward by a short frustoconical portion 14d.

The top ring 14 also comprises a plurality of radial protuberances or protrusions 14e provided on the internal bore of the external axial skirt 14b, in the vicinity of its bottom end. The protrusions 14e are directed radially towards the inside and are evenly spaced relative to one another in the circumferential direction, i.e., the protrusions 14e are circumferentially spaced. Each protrusion 14e preferably forms a hook directed radially towards the inside, towards the bottom ring 16. In this example, the top ring 14 includes twelve protrusions 14e.

The protrusions 14e are preferably formed by axially deforming partly the bottom end of the axial skirt 14b with an appropriate tool in order to create local deformations of material which extend radially inwards. It is relatively easier to stamp bosses or protrusions 14a by deforming the skirt 14b axially rather than by forming radial deformations in the metal part. Additionally, the process for creating the protrusions 14e is relatively inexpensive since it is done during the stamping process of the top ring 14.

The bottom ring 16 includes an annular radial portion 16a extending radially opposite from the radial portion 14a of the top ring. The radial portion 16a extends generally towards the outside and upwardly by a toroidal portion 16b. The concave internal surface of the toroidal portion 16b forms the track or raceway for the rolling elements 18. The bottom ring 16 also includes a cylindrical portion 16c extending axially downward a small-diameter edge of the radial portion 16a and providing with a radially folded edge 16d at its end. The toroidal portion 16b of the bottom ring 16 and the external axial skirt 14b of the top ring 14 are separated radially from one another by an annular space 24 in which the seal 20 is mounted.

The seal 20 is preferably of one-piece construction and may be formed of a plastic or polymeric material by molding, for example polyamide (PA), polytetrafluoroethylene (PTFE), or natural or synthetic rubber. The seal 20 has an annular shape and includes an annular axial skirt or portion 30 and an annular lip 32 projecting radially inward from an axial bottom edge of the axial portion 30. The axial portion 30 and the lip 32 apply respectively a static sealing with the top ring 14 and a dynamic sealing with the bottom ring 16.

The axial portion 30 is delimited axially by two opposite annular radial surfaces 30a, 30b. The top radial surface 30a bears against a bottom surface of the radial portion 14a of the top ring 14 and forms a static sealing with the ring over 360°, i.e., about substantially the entire perimeter of the ring 14. The contact between the top radial surface 30a and the bottom surface of the radial portion 14a is located radially near the axial skirt 14b. The bottom radial surface 30b is approximately situated in a radial plane containing the bottom end surface of the axial skirt 14b of the top ring.

The axial portion 30 comprises an annular rib 34 extending radially outwards, towards the axial skirt 14b of the top ring 14. An annular outer surface 34a of the rib 34 frictionally contacts the internal bore of the external axial skirt 14b of the top ring 14. Therefore, the annular rib 34 forms an external static sealing contact with the top ring 14 over 360° (i.e., about the entire perimeter of the ring 14).

The seal 20 is rotationally coupled or attached with the top ring 14 due mainly to the frictional contact forces between the annular rib 34 and the axial skirt 14b. Preferably, the diameter of the outer surface 34a of the annular rib 34, in a free state, is greater than the internal diameter of the bore of the external axial skirt 14b such that the seal 20 and the skirt 14b are coupled by an interference fit. The interference fit prevents rotation of the seal 20 relative to the top ring 14. Additionally, the interference fit between the outer surface 34a of the annular rib 34 and the axial skirt 14b enhances the efficiency of the static sealing between these two elements. The annular rib 34 is adapted to form a means for fixing or attaching the seal 20 to the top ring 14 in the circumferential direction.

The annular rib 34 is also adapted to cooperate with the radial protrusions 14e of the skirt 14 of the top ring 14 to serve as a retainer for axially retaining the seal relative to the top ring 14. An annular bottom radial surface 34b of the rib 34 bears against the top surfaces of the radial protrusions 14e of the skirt 14. The external diameter of the radial rib 34 is greater than the inner diameter of the radial protrusions 14e so that a diametrical interference exists between the seal 20 and the top ring 14 to prevent an axial displacement of said seal 20 downward. The annular rib 34 therefore forms an axial retention means interacting with a complementary axial retention means of the top ring 14 and axially positioned above the latter. The seal 20 is locked in axial direction downward and upward respectively by the radial protrusions 14e and the radial portion 14a of the top ring 14. Axial narrow passageways are formed between the internal edges of the radial protrusions 14e and the axial portion 30 of the seal.

The seal 20 also includes an annular chamfer 34c in the form of a frustoconical surface linking the outer surface 34a of the rib 34 and the top radial surface 30a of the axial portion 30. The chamfer 34c is adapted to cooperate with the internal edges of the radial protrusions 14e of the top ring 14 when the seal 20 is mounted between said top ring and the bottom ring 16. Specifically, the seal 20 is mounted between said rings with a simple axial pushing movement on the bottom radial surface 30b. With the axial pushing movement, when the chamfer 34c bears against the internal edges of the radial protrusions 14e, by virtue of the frustoconical form of said chamfer, the axial portion 30 is radially moved towards the bottom ring 16 until the ridge between the chamfer 34c and the outer surface 34a of the rib 34 reaches the internal edges of the radial protrusions 14e. Then, the axial portion 30 partly recovers by elasticity its initial shape. The seal 20 is still axially pushed until the top radial surface 30a comes into contact with the bottom radial surface of radial portion 14a of the outer ring 14. In this mounted position, the bottom radial surface 34b and the outer surface 34a of the rib 34 are respectively in frictional contact or engagement with the radial protrusions 14e and the skirt 14b of the top ring 14.

In the illustrated embodiment, the bottom surfaces of the protrusions 14e extend in a common radial plane. Alternatively, it may also be possible to foresee for these bottom surfaces an inclined form similar to the one of the chamfer 34c to ensure during the installation of the seal 20 inside the top ring 14, a smooth and progressive radial deformation inwards of the axial portion 30 of the seal. To this end, some local recesses may be provided in the thickness of the axial portion to enhance its flexibility.

The annular lip 32 extends obliquely downwards from the bottom edge of the axial portion 30 and is radially offset inwards relative to the bottom radial surface 30b of said portion. The lip 32 frictionally contacts the outer surface of the toroidal portion 16b of the bottom ring 16. The lip 32 forms an internal dynamic sealing with the bottom ring 16.

The annular lip 32 is also functions as an axial retainer and is configured to axially retain the bottom ring 16 relative to the top ring 14 before the rolling bearing 10 is mounted into the suspension thrust bearing device. To this end, the inner diameter of the lip 32 is smaller than the outer diameter of the bottom ring 16.

As mentioned above, the seal 20 is preferably used to close or enclose the external space 24 delimited between the toroidal portion 16b of the bottom ring 16 and the external axial skirt 14b of the top ring 14. In order to close the internal annular space delimited between the radial portion 16a of the bottom ring and the frustoconical portion 14d of the top ring, the cage 22 includes a lip having a first annular radial extension 22a which frictionally contacts the frustoconical portion 14d and a second annular axial extension 22b extending a small-diameter edge of said first radial extension and bearing against the bore of the cylindrical portion 16c of the bottom ring 16.

It should be noted that the embodiment illustrated and described was given merely by way of a non-limiting indicative example and that modifications and variations are possible within the scope of the invention. Thus, the invention applies not only to an angular contact ball bearing with a single row of balls but also to other types of rolling bearing, for example bearings having four points contacts and/or with double rows of balls, or with at least three rows of balls.

It is easily understood that it could also be possible to use bearing with other types of rolling members such as rollers. Otherwise, in the illustrated embodiment, the protrusions of the top ring are spaced relative to one another in the circumferential direction. Alternatively, it may also be possible to form a circumferentially continuous protrusion or rib on the internal edge of the external axial skirt of the top ring to cooperate with the annular outer rib of the seal.

The specific structure of the rib of the seal having a circumferentially continuous outer surface in friction contact with the skirt of the top ring permits to obtain a seal particularly easy to mount into the rolling bearing with a simple axial pushing movement without angular orientation. Additionally, the seal is fixed to the top ring without using an additional component.

We claim:

1. A rolling bearing comprising:
a bottom ring;
a top ring having a skirt with at least one radial protrusion;
a plurality of rolling elements disposed between the rings; and
a seal radially disposed between the top and bottom rings and including an annular radial rib, the rib being positioned axially above the radial protrusion of the top ring skirt so as to interfere diametrically with the radial protrusion and configured to frictionally contact the skirt to attach the seal to the top ring, and an axial retainer configured to axially retain the bottom ring relative to the top ring.

2. The rolling bearing according to claim 1, wherein the skirt has an internal diameter and the annular radial rib has an external diameter, the rib diameter in a free state being greater than the skirt internal diameter such that the seal and skirt are coupled by an interference fit.

3. The rolling bearing according to claim 1, wherein the top ring has a radial portion and the seal includes an annular top radial surface in contact with the radial portion of the top ring so as to statically seal with the top ring.

4. The rolling bearing according to claim 3, wherein the seal has a chamfer with a frustoconical surface disposed between the top radial surface and the annular radial rib.

5. The rolling bearing according to claim 1, wherein the skirt includes a plurality of circumferentially spaced radial protrusions.

6. The rolling bearing according to claim 1, wherein the skirt includes an annular radial protrusion.

7. The rolling bearing according to claim 1 wherein the skirt is deformed axially to form the at least one radial protrusion of the top ring.

8. The rolling bearing according to claim 1, wherein the axial retainer includes an annular lip frictionally contacting the bottom ring.

9. The rolling bearing according to claim 1 further comprising a cage configured to maintain a circumferential spacing between the rolling elements, the cage having at least two extensions each frictionally contacting the bottom ring and the top ring.

10. A suspension thrust bearing device comprising:
a rolling bearing including a bottom ring, a top ring having a skirt with at least one radial protrusion, a plurality of rolling elements disposed between the rings, and a seal radially disposed between the top and bottom rings and including an annular radial rib, the rib being positioned axially above the radial protrusion of the top ring skirt so as to interfere diametrically with the radial protrusion and configured to frictionally contact the skirt to attach the seal to the top ring, and a retainer configured to axially retain the bottom ring relative to the top ring; and
a support element for the rolling bearing forming bearing means for a spring.

11. A suspension strut for a motor vehicle comprising:
a suspension thrust bearing device including a rolling bearing, the rolling bearing having a bottom ring, a top ring having a skirt with at least one radial protrusion, a plurality of rolling elements disposed between the rings, and a seal radially disposed between the top and bottom rings and including an annular radial rib, the rib being positioned axially above the radial protrusion of the top ring skirt so as to interfere diametrically with the radial protrusion and configured to frictionally contact the skirt to attach the seal to the top ring, and a retainer configured to axially retain the bottom ring relative to the top ring, and a support element for the rolling bearing forming bearing means for a spring.
